(19) United States
(12) Patent Application Publication
(10) Pub. No.: US 2022/0207686 A1
(43) Pub. Date: Jun. 30, 2022

(54) SYSTEM AND METHOD FOR INSPECTING AN OBJECT FOR DEFECTS

(71) Applicant: Vitrox Technologies Sdn. Bhd., Bandar Cassia (MY)

(72) Inventors: SHIN JIE WONG, BATU MAUNG (MY); HM FAZLE RABBI, SIMPANG AMPAT (MY); JUNE WAI YAP, SIMPANG AMPAT (MY); ZHAO HONG LIM, NIBONG TEBAL (MY); ZHAO LUN LEE, SIMPANG AMPAT (MY)

(21) Appl. No.: 17/564,878

(22) Filed: Dec. 29, 2021

(30) Foreign Application Priority Data
Dec. 30, 2020 (MY) PI2020007196

(51) Int. Cl. G06T 7/00; G06T 17/00; G06V 10/764; G06V 20/64

(52) U.S. Cl. CPC G06T 7/001; G06T 17/00; G06V 10/764; G06T 2207/30141; G06T 2207/30148; G06T 2207/20081; G06V 20/64

(57) ABSTRACT

A system for inspecting an object for defects includes a component inspecting module (4) and an inspecting module (7). The system executes the following steps: identifying at least one component (400) and detecting defects of the identified component (400) through comparing one or more characteristics of at least one element of the component (400) with those of a specimen, wherein the components (400) of the object, upon being identified, are each assigned a corresponding inspection algorithm (307) by an assigning module (6) based on an inspection criteria for the object to be inspected.

### CROSS-REFERENCE TO RELATED APPLICATION

The instant application claims priority to Malaysia Patent Application Serial No. PI2020007196 filed Dec. 30, 2020, the entire specification of which is expressly incorporated herein by reference.

### FIELD OF THE INVENTION

The present invention relates to a system and method for inspecting an object for defects, more particularly for an object in a surface mounted technology production line.

### BACKGROUND OF THE INVENTION

Automated optical inspection (AOI) systems are used to inspect objects, preferably printed circuit boards (PCBs) for a variety of defects. The current generation of AOI systems place a significant burden on the operators of these systems to develop programs that will enable the system to classify specific defects on a PCB. This makes current AOI systems exceedingly difficult to use. In manufacturing these PCBs, a defect review system is typically used to classify defects and help to narrow down the root cause of a defect or an excursion of the manufacturing process. This is achieved by acquiring high resolution images around defect areas which is then reviewed by the system or the operator, in which the defects are classified into categories in accordance with the type of defects and how the defects may affect the production yield. The current state of the art in automatic defect classification still requires operator intervention since typical automated techniques still leave a significant portion of defects unclassified.

Many technologies related to inspecting objects for defects using the AOI system have been proposed to further improve said system. For example, a United States patent application with publication no. U.S. Pat. No. 6,621,566B1 discloses an AOI system which includes component learning integrated with the inspection of a circuit board. The AOI system includes a component learning area that can be viewed by an imaging system used to inspect the circuit board in an inspection area, wherein the component learning area can correspond to a region proximate the inspection area. Further, the AOI system receives board inspection and component learning requests and determines opportune times to learn new component characteristics during the board inspection process so as to minimize the impact of the learning process on the overall inspection efficiency. Another United States patent application with publication no. U.S. Pat. No. 6,597,381B1 discloses a user interface method and system to allow for user selection on a display device of one or more functions performed via a computer in the AOI system. The user interface provides a real-time information display that makes apparent critical board inspection information and potential undesirable operating conditions so that corrective action can be rapidly initiated.

Besides that, a technology as disclosed in a Unites States patent application with publication no. U.S. Pat. No. 7,167,583B1 recites an inspection system comprising a plurality of models applied in a way that enhances the effectiveness of each type of model. In one embodiment of the application, a printed circuit board inspection system includes an image model, a structural model and a geometric model to inspect objects. The image model is first applied to an object being inspected to identify objects which look alike, in which a structural model is applied to determine whether the objects in the image that has the same structure and is used to decide if the image model has found a part in the image. Lastly, a geometric model is applied and an approximate positional data provided by the previous two models is used to determine the location of the object being inspected. Further, a United States patent application with publication no. US20160163035A1 discloses a system and method for defection classification in a semiconductor process which includes a communication line configured to receive a defect image of a wafer from the semiconductor process and a deep-architecture neural network in electronic communication with the communication line. The neural network first configures pixels from the defect image with a filter to generate a first feature map which is subsequently reduced with a first subsampling layer. A classifier is then provided to determine a defect classification based on the feature map.

The aforementioned patent documents describe the many configurations of an automated optical inspection (AOI) system for inspecting objects for defects. A major drawback arises as most conventional systems are unable to narrow down an inspection area to check a specific part of a component in the printed circuit board. The prior inventions inspect the components within a boundary box which they are located therein. This is undesirable as it may miss out on certain defects which might not be detected in a large boundary box.

Therefore there exists a need to provide an AOI system with such configuration, particularly being able to accurately perform detection on small regions of the components and sub-components according to standards set by the Institute of Interconnecting and Packing Electronic Circuits (IPC).

### SUMMARY OF THE INVENTION

It is an object of the invention to provide a system and method capable of detecting defects in an automated surface mount technology production line without user interference. It is also an object of the present invention to reduce a set up time for an automated optical inspection (AOI) program and improve defect detection coverage. Advantageously, the system also provides a better handling of defect detections especially to inexperienced engineers in the field.

In an aspect of the present invention, there is provided a computer-implemented system for inspecting an object for defects comprising a component inspecting module for identifying at least one component of the object; and an inspecting module for detecting defects of the identified component through comparing one or more characteristics of at least one element of the component with those of a specimen, wherein the components of the object, upon being identified, are each assigned a corresponding inspection algorithm by an assigning module based on an inspection criteria for the object to be inspected.

Preferably, the system further comprises an image capturing device for capturing one or more images of the object.

Preferably, the system further comprises a model constructor for creating a three-dimensional model of the object.

Preferably, the system further comprises an object recognizing module for recognizing the object.

Preferably, the system further comprises an element detecting module for detecting characteristics of the element of the component.

Preferably, the characteristics of the element include presence, type and measurable parameter of the element.

Preferably, the system further comprises one or more measuring devices for measuring the parameter of the element.

Preferably, the system further comprises a database for storing learned characteristics of the specimen and information of inspection criteria that define comparison references.

Preferably, the system further comprising a condition determining module for determining a condition of the component based on an inspection outcome of the object.

Preferably, the system further comprises a classifier for classifying conditions of the component.

Preferably, the system further comprises a solution provider for providing guidelines to rectify the defects.

Preferably, the object is an integrated circuit package.

In another aspect of the present invention, there is provided a computer-implemented method for inspecting an object for defects comprising the steps of identifying at least one component of the object by a component identifying module; and detecting defects of the identified component through comparing one or more characteristics of at least one element of the component with those of a specimen by an inspecting module, wherein the component of the object, upon being identified, are each assigned a corresponding inspection algorithm by an assigning module based on an inspection criteria for the object to be inspected.

Preferably, the method further comprising the step of providing training inputs to the computer based on the inspection criteria and characteristics of the specimen for generating the inspection algorithm to be assigned to the components of the object.

Preferably, the method further comprises the step of capturing one or more images of the object by an image capturing device from one or more perspectives of the object.

Preferably, the method further comprising the step of creating a three-dimensional model of the object based on the captured images by a model constructor.

Preferably, the method further comprises the step of recognizing the object by an object recognizing module prior to or concurrently with the step of identifying the component of the object.

Preferably, the method further comprises the step of detecting characteristics of the element of the component by an element detecting module through detecting presence, type, measuring parameters of the element, or a combination thereof.

Preferably, the method further comprising the step of determining condition of the component based on inspection outcome of the object by a condition determining module.

Preferably, the method further comprises the step of classifying condition of the condition by a classifier.

Preferably, the method further comprises the step of providing guidelines to rectify the defects by a solution provider.

Preferably, the object is an integrated circuit package.

One skilled in the art will readily appreciate that the present invention is well adapted to carry out the objects and obtain the ends and advantages mentioned, as well as those inherent therein. The embodiment described herein is not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a block diagram of a system for a system for inspecting an object for defects.

FIG. 2 is a flow chart illustrating an exemplary embodiment for a method for inspecting an object for defects.

FIG. 3 is a flowchart illustrating a process for learning a component.

FIG. 4A illustrates an exemplary embodiment of a 2D image of the component with leads.

FIG. 4B illustrates an exemplary embodiment of the 2D image of the component without leads.

FIG. 5A illustrates an exemplary embodiment of a 3D image of the component with leads.

FIG. 5B illustrates an exemplary embodiment of the 3D image of the component without leads.

FIG. 6A illustrates an exemplary embodiment of a billboard defect.

FIG. 6B illustrates an exemplary embodiment of a location offset defect.

FIG. 6C illustrates an exemplary embodiment of a coplanarity defect.

FIG. 6D illustrates an exemplary embodiment of a tombstone defect.

FIG. 6E illustrates an exemplary embodiment of the defect with a missing component.

FIG. 6F illustrates an exemplary embodiment of the defect with an absent element.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

Before describing the system and method of the present invention, it should be appreciated that, in an effort to promote clarity, reference is sometimes made herein to inspection of certain objects performed in a particular field of use. Such references and accompanying examples are only intended to facilitate an appreciation of the invention and should not be taken as limiting use of the concepts described herein to use with only systems of the type described herein. Rather, as mentioned above, the present invention finds application in a wide variety of different fields and generally finds application to the problem of object recognition or detection. The present invention can be used to recognize and/or detect objects such as wafer defects. Reference is also made herein to inspection of certain objects such as printed circuit boards and circuit components disposed on printed circuit boards. As described herein, a circuit component or more simply, a component, refers to a part of such an integrated circuit package which is mounted or otherwise coupled to a printed circuit board (PCB). The object may also be a printed circuit board defect and the PCB may be of any type.

Those of ordinary skill in the art will appreciate that the principles of the present invention can find use in a variety of applications including, but not limited to, inspection of printed circuit boards and components as well as inspection of any other types of objects. For example, the present invention finds applications where one object is disposed over and possibly in contact with or in close proximity with another object or where one object is embedded in another object. Likewise, the techniques described herein may be used for any type of printed circuit board or circuit board component without regard to its function.

It will also be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

The invention will now be described in greater detail, by way of example with reference to the drawings.

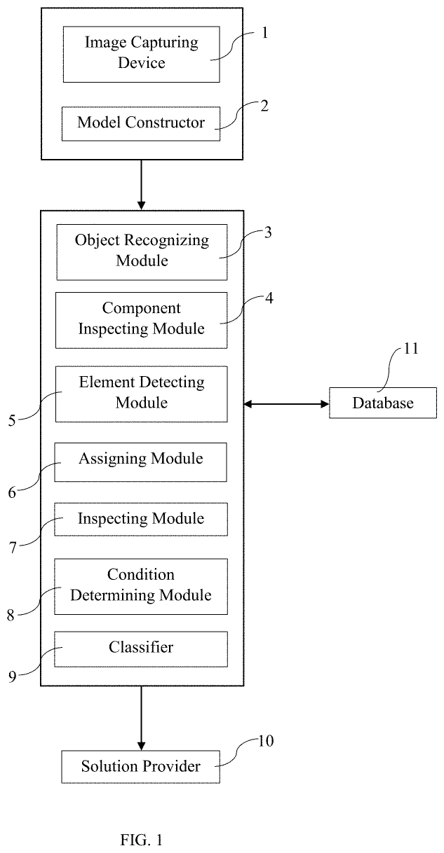

FIG. 1 is a block diagram illustrating a preferred embodiment of a computer-implemented system for inspecting an object for defects, more particularly in an automated optical inspection (AOI) machine. In a preferred embodiment, the system comprises a component inspecting module 4, configured to identify at least one component of the object and an inspecting module 7 for detecting defects of the identified component 400 through comparing one or more characteristics of at least one element of the component 400 with those of a specimen, wherein the components 400 of the object, upon being identified, are each assigned a corresponding inspection algorithm 307 by an assigning module 6 based on an inspection criteria for the object to be inspected. Preferably, the inspection criteria may be IPC standards which are electronics-industry-adopted standard for design, printed circuit board manufacturing and electronic assembly issued by the Association Connecting Electronics Industries, formerly known as the Institute for Printed Circuits. Additionally, the IPC standards are classified into three different classes, Class 1 for general electronic products, Class 2 for dedicated service electronic products, and Class 3 for high performance electric products. Such an example of the IPC standards being applied is IPC-A-610 for AOI: Integrated Verification Enables IPC-compliant PCB inspection, which is a universally accepted standard for electronics assembly defects. An extension of this standard IPC-A-610D may also be applied as this standard recites a “collection of visual quality acceptability requirements for electronic assemblies.”

In a preferred embodiment, the system employs an image capturing device 1 for capturing one or more images of the object to be inspected. The image capturing device 1 can include one or more cameras for capturing one or more images of the object. The image capturing device 1 may also move along a predetermined path to capture images of desired portions of the object. Preferably, a plurality of illumination units is disposed surrounding the image capturing device 1 to illuminate the object. Further, the illumination units are disposed at an angle towards the centre of the image capturing device 1 to focus light at a predetermined area on the object, enhancing the quality of the captured image to be processed for training the system to detect specific defects in the object. Once a sufficient amount of images has been captured, the captured images will be processed by a model constructor 2 to create a three-dimensional model of the object and its components 400, wherein the components 400.

In a particular embodiment, the system further comprising an object recognizing module 3 for recognizing the object based on one or more characteristics of the object. The characteristics may include the type, dimensions, absence or presence of components 400 and shape of the object or the likes. Similarly, the parameters for the elements of the component are measured. Preferably, all characteristics of the object, preferably a specimen object, and information of the inspection criteria for the specimen object are stored in a database 11 which can be accessed during inspection of other objects in a production line.

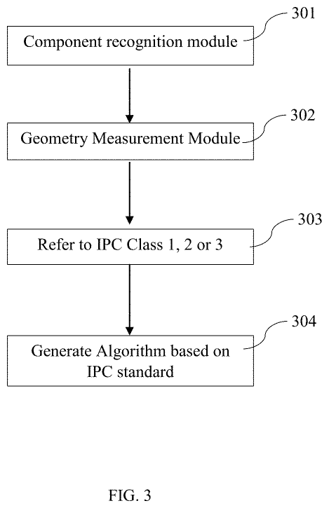

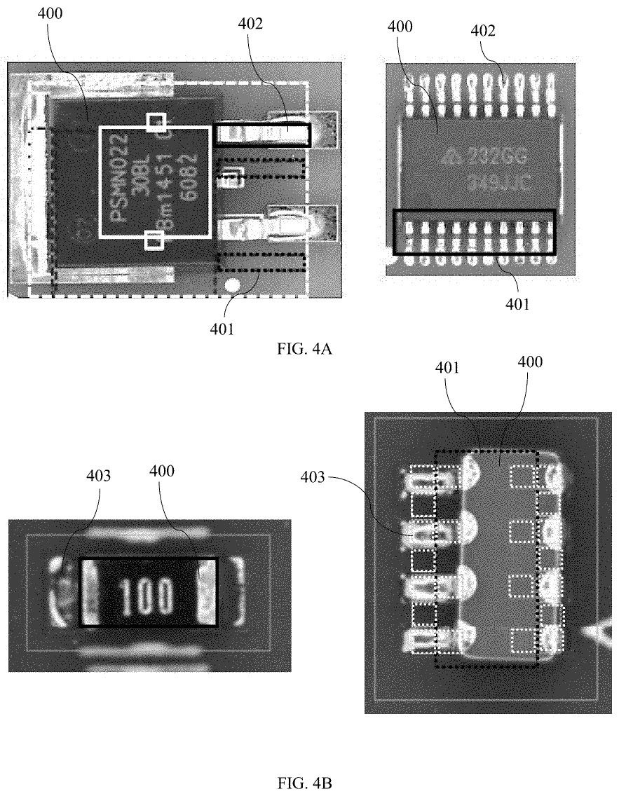

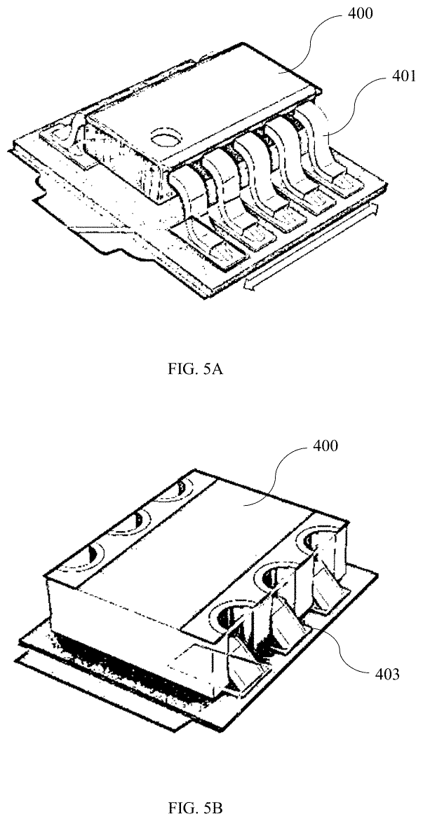

In another particular embodiment, the system further comprises an element detecting module 5 for detecting characteristics of the element of the component 400. Referring to FIG. 4A & FIG. 5A, the element of the component 400 may include a lead 401 for connecting the component 400 to the printed circuit board, in which the prevalent characteristic for said element may be the absence or presence of the lead 401 for each detected component 400 in the printed circuit board. For components which do not have leads 401, the components 400 may be soldered directly to the printed circuit board via a pad 403 such as illustrated in FIG. 4B & FIG. 5B. The pad 403 is a small surface of copper in the printed circuit board which allows soldering the component to the board. Some components may not require leads 401 for attaching to the printed circuit board, but can be soldered on directly to the pad 403.

In another particular embodiment, the system further comprising a condition determining module 8 for determining a condition of the component 400 based on the inspection outcome of the object. The overall condition of the component 400 may then classified as either good or defective, by a classifier 9 integrated in the system, in which the defects on the defective component 400 may vary depending on the type of component being inspected, which will be further discussed herein.

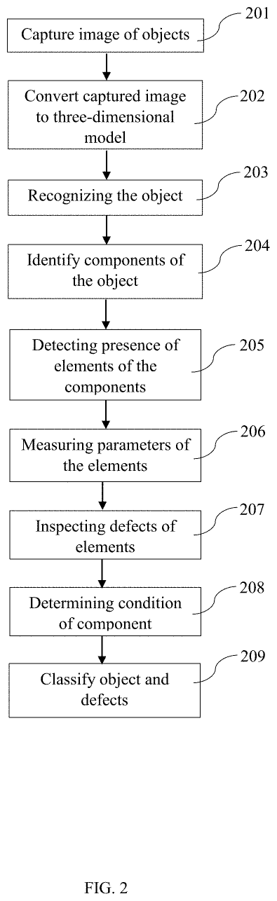

FIG. 2 is a flowchart illustrating a preferred embodiment for inspecting an object for defects based on the above-mentioned system. At Step 201, the image capturing device 1 first captures one or more images of the object to be inspected. At Step 202, the captured images will then be used to generate the three-dimensional model by the model constructor 2. At Step 203, the object recognizing module 3 will perform recognition of the object to detect regions of the object based on one or more characteristics of the object. At Step 204, the component identifying module 4 will identify components 400 of the objects based on one of more characteristics of the component 400, such as presence, type, and parameters of the component 400 including its overall dimensions. Once each component 400 has been recognised by the system, the assigning module 6 will assign inspection algorithms 307 corresponding to said component 400 to have its defects be inspected thoroughly. At Step 205, the element detecting module 5 will then attempt to detect the presence of elements of the components 400. At Step 206, one or more measuring devices are used to measure the parameters of the elements of the components such as the height, length, and width of the element. At Step 207, the inspecting module 7 will then inspect any defects on the elements by comparing the characteristics of the components 400 and elements with learned characteristics of the specimen object stored in the database 11. After inspecting any or all defects present in the inspected object, the condition determining module 8 will determine the condition of the component 400 with respect to the detected defects at Step 208. The defects and the overall characteristics of the object will then be classified accordingly via a classifier 9 integrated in the system. Any defects or problematic parameters in the system will cause the system to alert the user of the problem, in which the solution provider 10 will then provide guidelines for rectifying the defect or parameter.

FIG. 3 is a flow chart an exemplary embodiment for recognizing a component 400 and its elements. Upon creation of the three-dimensional model of the components 400, the system will proceed to identify each component by the component inspecting module 4, according to the captured images, as illustrated in Step 301 of FIG. 3. In order to identify the components 400 in the object, the system has to be firstly trained by providing training inputs such as a computer-aided design (CAD) model of an ideal specimen object and images captured of the specimen object itself. Based on the captured images of the specimen object, the component inspecting module 4 will highlight each component 400 present in the printed circuit board with at least one boundary box 401, such as illustrated in FIGS. 4A and 4B. Once the system successfully identifies and recognizes the components 400, the system then employs the element detecting module 5 at Step 302 for detecting characteristics of elements of said components 400, such as width, length and height. The system will refer to either one of the three IPC classes at Step 303. At Step 304, the assigning module 6 will then generate the algorithm for each component 400 present on the object for more in-depth inspection for potential defects.

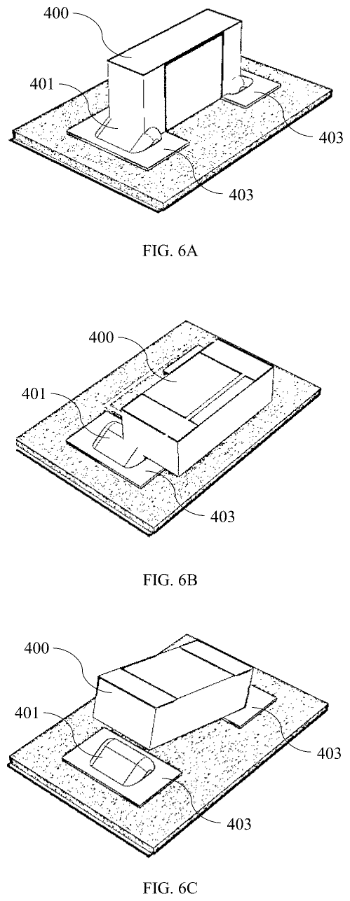

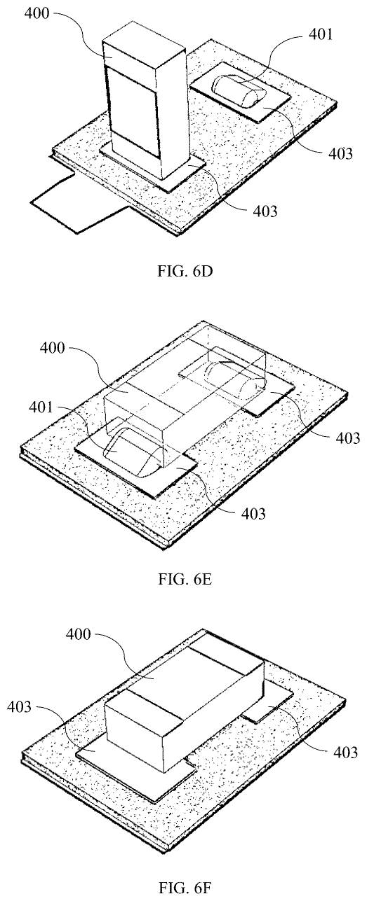

FIG. 6A to FIG. 6B illustrates exemplary embodiments of the various defects that may be detected on the components 400. Taking the chip resistor as an example, its corresponding defects may include, by way of example but not limited to, a billboard in FIG. 6A, a location offset in FIG. 6B, coplanarity in FIG. 6C, a tombstone in FIG. 6D, absence of the component 400 in FIG. 6E, absence of the element in FIG. 6F, and so on. The billboard, coplanarity, and tombstone defects are mainly caused by the orientation of the component 400 body, whereby one end of the component is not soldered onto the printed circuit board. The absence of element may refer to either the absence of the lead 401 or a solder point between the components 400 to the pad 403. It can be seen clearly that each defect will have certain differences in orientation, location and/or presence when compared to the specimen object. Depending on the IPC class set by the operator, a predetermined acceptable tolerance for each defect is applied to the inspection algorithm, whereby if the difference in parameters exceeds the acceptable tolerance, the system will issue a warning to the operator and the solution provider 10 will be subsequently employed to provide guidelines to rectify the defects.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

What is claimed is:

1. A computer-implemented system for inspecting an object for defects, comprising:
a component inspecting module for identifying at least one component of the object; and
an inspecting module for detecting defects of the identified component through comparing one or more characteristics of at least one element of the component with those of a specimen;
wherein the components of the object, upon being identified, are each assigned a corresponding inspection algorithm by an assigning module based on an inspection criteria for the object to be inspected.

2. The computer-implemented system according to claim 1, further comprising an image capturing device for capturing one or more images of the object.

3. The computer-implemented system according to claim 2, further comprising a model constructor for creating a three-dimensional model of the object based on the captured images.

4. The computer-implemented system according to claim 3, further comprising an object recognizing module for recognizing the object.

5. The computer-implemented system according to claim 4, further comprising an element detecting module for detecting characteristics of the element of the component.

6. The computer-implemented system according to claim 5, wherein the characteristics of the element include presence, type and measurable parameter of the element.

7. The computer-implemented system according to claim 6, further comprising one or more measuring devices for measuring the parameter of the element.

8. The computer-implemented system according to claim 7, further comprising a database for storing learned characteristics of the specimen and information of inspection criteria that define comparison references.

9. The computer-implemented system according to claim 8, further comprising a condition determining module for determining a condition of the component based on inspection outcome of the object.

10. The computer-implemented system according to claim 9, further comprising a classifier for classifying condition of the component.

11. The computer-implemented system according to claim 10, further comprising a solution provider for providing guidelines to rectify the defects.

12. The computer-implemented system according to claim 11, wherein the object is an integrated circuit package.

13. A computer-implemented method for inspecting an object for defects, comprising the steps of:
identifying at least one component of the object by a component identifying module;
detecting defects of the identified component through comparing one or more characteristics of at least one element of the component with those of a specimen by an inspecting module;
wherein the components of the object, upon being identified, are each assigned a corresponding inspection algorithm by an assigning module based on an inspection criteria for the object to be inspected.

14. The computer-implemented method according to claim 13, further comprising the step of providing training inputs to the computer based on the inspection criteria and characteristics of the specimen for generating the inspection algorithm to be assigned to the components of the object.

15. The computer-implemented method according to claim 14, further comprising the step of capturing one or more images of the object by an image capturing device from one or more perspective of the object.

16. The computer-implemented method according to claim 15, further comprising the step of creating a three-dimensional model of the object based on the captured images by a model constructor.

17. The computer-implemented method according to claim 16, further comprising the step of recognizing the object by an object recognizing module prior to or concurrently with the step of identifying the component of the object.

18. The computer-implemented method according to claim 17, further comprising the step of detecting characteristics of the element of the component by an element detecting module through detecting presence, type, measuring parameters of the element, or a combination thereof.

19. The computer-implemented method according to claim 18, further comprising the step of determining condition of the component based on inspection outcome of the object by a condition determining module.

20. The computer-implemented method according to claim 19, further comprising the step of classifying condition of the component by a classifier.

21. The computer-implemented method according to claim 20, further comprising the step of providing guidelines to rectify the defects by a solution provider.

22. The computer-implemented method according to claim 21, wherein the object is an integrated circuit package.
